(19) United States
(12) Patent Application Publication
(10) Pub. No.: US 2025/0008437 A1
(43) Pub. Date: Jan. 2, 2025

(54) METHOD AND DEVICE USED IN COMMUNICATION NODE FOR WIRELESS COMMUNICATION

(71) Applicants: Qiaoling YU, Shanghai (CN); Xiaobo ZHANG, Shanghai (CN)

(72) Inventors: Qiaoling YU, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/885,571

(22) Filed: Sep. 14, 2024

Related U.S. Application Data
(63) Continuation of application No. PCT/CN2023/081919, filed on Mar. 16, 2023.

(30) Foreign Application Priority Data
Mar. 18, 2022 (CN) 202210273378.3

(51) Int. Cl. H04W 52/02; H04W 76/27

(52) U.S. Cl. CPC H04W 52/0229; H04W 76/27

(57) ABSTRACT

The communication node receives a first message, the first message indicating a target radio bearer set; and determines whether to perform a first action set according to whether a first condition set is satisfied, the first action set including suspending a first radio bearer; the target radio bearer set includes at least one radio bearer, and the first radio bearer is one radio bearer in the target radio bearer set; a condition in the first condition set is related to a second message, the second message being used to determine whether to maintain a state of the first radio bearer; the first action set is performed if the first condition set is satisfied; and the first action set is not performed if at least one condition in the first condition set is not satisfied.

### CROSS REFERENCE TO RELATED APPLICATIONS

This application is the continuation of the international patent application No. PCT/CN2023/081919, filed on Mar. 16,2023, and claims the priority benefit of Chinese Patent Application No.202210273378.3, filed on Mar. 18,2022, the full disclosure of which is incorporated herein by reference.

### BACKGROUND

### Technical Field

The present application relates to transmission methods and devices in wireless communication systems, and in particular to a method and device for transmitting data in RRC inactive state.

### Related Art

New Radio (NR) supports Radio Resource Control_INACTIVE (RRC_INACTIVE) State till the 3rd Generation Partnership Project (3GPP) Rel-16 in which transmitting or receiving data in the RRC_INACTIVE state is not supported. Rel-17 carried out a Work Item (WI) on “Small Data Transmission (SDT) in NR Inactive State” to investigate small data transmission techniques in the RRC_INACTIVE state, including transmitting uplink data on pre-configured Physical Uplink Shared Channel (PUSCH) resources, or carrying data by means of either a Message 3 (Msg3) or a Message B (MsgB) in a Random Access (RA) procedure; Rel-17 carried out a Work Item (WI) on “receiving Multicast/Broadcast Service (MBS) in RRC connected state”; Rel-18 investigates the reception of MBS in RRC_INACTIVE state, and Rel-18 investigates downlink data transmission in the RRC_INACTIVE state.

### SUMMARY

In the prior art, when a UE (i.e., UserEquipment) enters the RRC inactive state upon receiving an RRCRelease message sent by a base station, it will suspend all Signalling Radio Bearers (SRBs), (user) Data Radio Bearers (DRBs) and multicast MBS Radio Bearer (MRBs), so that the UE cannot continue to transmit data when it enters the RRC inactive state. If it is indicated that the UE enters the RRC inactive state and the UE is configured with SDT, when the UE has data to transmit in the RRC inactive state and if conditions for SDT are met, it performs the SDT procedure through an RRC recovery procedure. Since being in the RRC inactive state is power-efficient for the UE, how to make the UE to enter the RRC inactive state in advance as it performs data transmission needs to be enhanced.

To address the above problem, the present application provides a solution. In the description of the above problem, New Radio (NR) scenario is used as an example; the present application is equally applicable to scenarios such as Long Term Evolution (LTE) or Narrow Band Internet of Things (NB-IoT) where similar technical effect can be achieved. Additionally, the adoption of a unified solution for various scenarios contributes to the reduction of hardcore complexity and costs.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

The present application provides a method in a first node for wireless communications, comprising:
receiving a first message, the first message indicating a target radio bearer set, the first message being used to determine to enter or to maintain RRC inactive state; and as a response to the first message being received, determining whether to perform a first action set at least according to whether a first condition set is satisfied, the first action set including suspending a first radio bearer;
herein, the target radio bearer set includes at least one radio bearer, and the first radio bearer is one radio bearer in the target radio bearer set; a condition in the first condition set is related to a second message, the second message being used to determine whether to maintain a state of the first radio bearer; the action of determining whether to perform a first action set at least according to whether a first condition set is satisfied includes: performing the first action set if the first condition set is satisfied; and the first action set being not performed if at least one condition in the first condition set is not satisfied.

In one embodiment, a problem to be solved in the present application includes: how to reduce UE power consumption.

In one embodiment, a problem to be solved in the present application includes: how to enable the UE to enter RRC inactive state in advance.

In one embodiment, a problem to be solved in the present application includes: how to support the maintenance of the radio bearer's state when the UE enters RRC inactive state.

In one embodiment, a problem to be solved in the present application includes: how to avoid data interruption during state transition.

In one embodiment, a problem to be solved in the present application includes: how to enable the UE to enter the RRC inactive state earlier while continuing data transmission.

In one embodiment, characteristics of the above method include: the second message being a part of the first message.

In one embodiment, characteristics of the above method include: the second message not being a part of the first message.

In one embodiment, characteristics of the above method include: the target radio bearer set being all radio bearers configured for SDT.

In one embodiment, characteristics of the above method include: the target radio bearer set being all DRBs configured for SDT.

In one embodiment, characteristics of the above method include: the target radio bearer set being all SRBs configured for SDT.

In one embodiment, characteristics of the above method include: the target radio bearer set being all radio bearers configured for multicast MBS.

In one embodiment, characteristics of the above method include: the target radio bearer set being all multicast MRBs configured for multicast MBS.

In one embodiment, characteristics of the above method include: the target radio bearer set being all SRBs configured for multicast MBS.

In one embodiment, an advantage of the above method includes: reducing UE power consumption.

In one embodiment, an advantage of the above method includes: avoiding data interruption.

According to one aspect of the present application, characterized in that the second message indicates whether to maintain states of all radio bearers in the target radio bearer set; the second message indicating maintaining of the states of all radio bearers in the target radio bearer set is used to determine maintaining of a state of the first radio bearer.

According to one aspect of the present application, characterized in that the second message indicates whether to maintain a state of each radio bearer in the target radio bearer set; the second message is a part of the first message.

According to one aspect of the present application, characterized in comprising:
maintaining the state of the first radio bearer as a response to receiving the first message if at least one condition in the first condition set is not satisfied.

According to one aspect of the present application, characterized in comprising:
starting a first timer as a response to receiving the first message if at least one condition in the first condition set is not satisfied; expiration of the first timer being used to determine to enter RRC idle state.

According to one aspect of the present application, characterized in comprising:
performing a second action set as a response to the first message being received;
herein, the action of performing the second action set is independent of whether the first condition set is satisfied; the second action set includes suspending at least a second radio bearer, the second radio bearer being not indicated by the first message.

According to one aspect of the present application, characterized in that the first action set includes resetting Medium Access Control (MAC).

The present application provides a method in a second node for wireless communications, comprising:
transmitting a first message, the first message indicating a target radio bearer set, the first message being used to determine to enter or to maintain RRC inactive state;
herein, as a response to the first message being received, at least whether a first condition set is satisfied is used to determine whether to perform a first action set, the first action set including suspending a first radio bearer; the target radio bearer set includes at least one radio bearer, and the first radio bearer is one radio bearer in the target radio bearer set; a condition in the first condition set is related to a second message, the second message being used to determine whether to maintain a state of the first radio bearer; the phrase that at least whether a first condition set is satisfied is used to determine whether to perform a first action set includes: the first action set being performed if the first condition set is satisfied; and the first action set being not performed if at least one condition in the first condition set is not satisfied.

According to one aspect of the present application, characterized in that the second message indicates whether to maintain states of all radio bearers in the target radio bearer set; the second message indicating maintaining of the states of all radio bearers in the target radio bearer set is used to determine maintaining of a state of the first radio bearer.

According to one aspect of the present application, characterized in that the second message indicates whether to maintain a state of each radio bearer in the target radio bearer set; the second message is a part of the first message.

According to one aspect of the present application, characterized in that if at least one condition in the first condition set is not satisfied, the state of the first radio bearer is maintained as a response to receiving the first message.

According to one aspect of the present application, characterized in that if at least one condition in the first condition set is not satisfied, a first timer is started as a response to receiving the first message; expiration of the first timer being used to determine to enter RRC idle state.

According to one aspect of the present application, characterized in that as a response to the first message being received, a second action set is performed; herein, the action of performing the second action set is independent of whether the first condition set is satisfied; the second action set includes suspending at least a second radio bearer, the second radio bearer being not indicated by the first message.

According to one aspect of the present application, characterized in that the first action set includes resetting MAC.

The present application provides a first node for wireless communications, comprising:
a first receiver, receiving a first message, the first message indicating a target radio bearer set, the first message being used to determine to enter or to maintain RRC inactive state; and as a response to the first message being received, determining whether to perform a first action set at least according to whether a first condition set is satisfied, the first action set including suspending a first radio bearer;
herein, the target radio bearer set includes at least one radio bearer, and the first radio bearer is one radio bearer in the target radio bearer set: a condition in the first condition set is related to a second message, the second message being used to determine whether to maintain a state of the first radio bearer; the action of determining whether to perform a first action set at least according to whether a first condition set is satisfied includes: performing the first action set if the first condition set is satisfied; and the first action set being not performed if at least one condition in the first condition set is not satisfied.

The present application provides a second node for wireless communications, comprising:
a second transmitter, transmitting a first message, the first message indicating a target radio bearer set, the first message being used to determine to enter or to maintain RRC inactive state;
herein, as a response to the first message being received, at least whether a first condition set is satisfied is used to determine whether to perform a first action set, the first action set including suspending a first radio bearer; the target radio bearer set includes at least one radio bearer, and the first radio bearer is one radio bearer in the target radio bearer set; a condition in the first condition set is related to a second message, the second message being used to determine whether to maintain a state of the first radio bearer; the phrase that at least whether a first condition set is satisfied is used to determine whether to perform a first action set includes: the first action set being performed if the first condition set is satisfied; and the first action set being not performed if at least one condition in the first condition set is not satisfied.

In one embodiment, compared with the prior art, the present application is advantageous in the following aspects:
supporting the UE to enter the RRC inactive state in advance;
supporting the UE to maintain the radio bearer's state as it receives the RRCRelease message;
reducing UE power consumption;
avoiding data interruption.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmission of a first message according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of radio signal transmission according to one embodiment of the present application.

FIG. 6 illustrates a schematic diagram of a second message indicating whether to maintain states of all radio bearers in a target radio bearer set according to one embodiment of the present application.

FIG. 7 illustrates a schematic diagram of a second message indicating whether to maintain a state of each radio bearer in a target radio bearer set according to one embodiment of the present application.

FIG. 8 illustrates a schematic diagram of a first action set including resetting MAC according to one embodiment of the present application.

FIG. 9 illustrates a schematic diagram of structures of a first message and a second message according to one embodiment of the present application.

FIG. 10 illustrates a schematic diagram of structures of a first message and a second message according to another embodiment of the present application.

FIG. 11 illustrates a schematic diagram of structures of a first message and a second message according to a third embodiment of the present application.

FIG. 12 illustrates a structure block diagram of a processing device used in a first node according to one embodiment of the present application.

FIG. 13 illustrates a structure block diagram of a processing device used in a second node according to one embodiment of the present application.

FIG. 14 illustrates a flowchart of radio signal transmission according to another embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of transmission of a first message according to one embodiment

of the present application, as shown in FIG. 1. In FIG. 1, each step represents a step, it should be particularly noted that the sequence order of each box herein does not imply a chronological order of steps marked respectively by these boxes.

In Embodiment 1, the first node in this application receives a first message in step 101, the first message indicating a target radio bearer set, the first message being used to determine to enter or to maintain RRC inactive state; and in step 102, as a response to the first message being received, determines whether to perform a first action set at least according to whether a first condition set is satisfied, the first action set including suspending a first radio bearer; herein, the target radio bearer set includes at least one radio bearer, and the first radio bearer is one radio bearer in the target radio bearer set; a condition in the first condition set is related to a second message, the second message being used to determine whether to maintain a state of the first radio bearer; the action of determining whether to perform a first action set at least according to whether a first condition set is satisfied includes: performing the first action set if the first condition set is satisfied; and the first action set being not performed if at least one condition in the first condition set is not satisfied.

In one embodiment, the target radio bearer set includes the Q1 radio bearers.

In one embodiment, the target radio bearer set includes Q1 DRBs, each of the Q1 DRBs being indicated by a DRB identifier.

In one subembodiment, Q1 is not less than 0, and, the Q1 is not greater than a first target integer, the first target integer being a non-negative integer.

In one subembodiment, Q1 is not less than 1, and, the Q1 is not greater than a first target integer, the first target integer being a non-negative integer.

In one subembodiment, the first target integer is equal to 29.

In one subembodiment, the first target integer is equal to 32.

In one subembodiment, the first target integer is a maximum number of DRBs that can be configured.

In one subembodiment, the first target integer is a maximum number of DRBs that can be added to a DRB-ToAddModList; each radio bearer in the target radio bearer set is a DRB.

In one subembodiment, if Q1 is equal to 0, no DRBs are included in the target radio bearer set.

In one subembodiment, a DRB identifier is indicated by a DRB-Identity.

In one subembodiment, a DRB-identifier is a non-negative integer.

In one subembodiment, a DRB identifier is an integer that is not less than 1 and not greater than 32.

In one subembodiment, a DRB identifier is an integer that is not less than 1 and not greater than 64.

In one embodiment, the target radio bearer set includes the Q2 radio bearers.

In one embodiment, the target radio bearer set includes Q2 multicast MRBs, each of the Q2 multicast MRBs being indicated by a multicast MRB identifier.

In one subembodiment, Q2 is not less than 0, and, the Q2 is not greater than a second target integer, the second target integer being a non-negative integer.

In one subembodiment, Q2 is not less than 1, and, the Q2 is not greater than a second target integer, the second target integer being a non-negative integer.

In one subembodiment, the second target integer is equal to 29.

In one subembodiment, the second target integer is equal to 32.

In one subembodiment, the second target integer is equal to 512.

In one subembodiment, the second target integer is equal to 1024.

In one subembodiment, the second target integer is a maximum number of multicast MRBs that can be configured.

In one subembodiment, the second target integer is a maximum number of multicast MRBs that can be added to a mrb-ToAddModList or mrb-ToAddModList-r17; each radio bearer in the target radio bearer set is an MRB.

In one subembodiment, if Q2 is equal to 0, no multicast MRBs are included in the target radio bearer set.

In one subembodiment, a multicast MRB identifier is indicated by an MRB-Identity.

In one subembodiment, a multicast MRB identifier is a non-negative integer.

In one subembodiment, a multicast MRB identifier is an integer that is not less than 1 and not greater than 32.

In one subembodiment, a multicast MRB identifier is an integer that is not less than 1 and not greater than 512.

In one subembodiment, a multicast MRB identifier is an integer that is not less than 1 and not greater than 1024.

In one embodiment, the target radio bearer set includes only the Q1 DRBs; the Q1 being greater than 0.

In one embodiment, the target radio bearer set includes only the Q2 multicast MRBs; the Q2 being greater than 0.

In one embodiment, the target radio bearer set includes only SRB2.

In one embodiment, the target radio bearer set includes at least one of the Q1 DRBs, or the Q2 multicast MRBs, or the SRB2.

In one embodiment, the first message comprises one RRC field, the one RRC field indicating that the SRB2 being configured is used to determine that the target radio bearer set includes SRB2.

In one subembodiment, the one RRC field includes sdt-SRB2-Indication in its name.

In one subembodiment, the one RRC field is an sdt-SRB2-Indication field.

In one subembodiment, the one RRC field is an sdt-SRB2-Indication field-r17.

In one embodiment, the first message is a higher layer signaling.

In one embodiment, the first message is an RRC layer Message.

In one embodiment, the first message comprises at least an RRC message.

In one embodiment, the first message comprises at least one RRC Information Element (IE).

In one embodiment, the first message comprises at least one RRC Field.

In one embodiment, the first message is a downlink message.

In one embodiment, the first message is a Sidelink (SL) message.

In one embodiment, a radio bearer for the first message is an SRB.

In one embodiment, a radio bearer for the first message is SRB1.

In one embodiment, the first message is transmitted via an MBS Control Channel (MCCH).

In one embodiment, the first message is transmitted via a Dedicated Control Channel (DCCH).

In one embodiment, the first message is an RRCRelease message.

In one embodiment, the first message is an RRCConnectionRelease message.

In one embodiment, the first message is an RRCRelease message, the RRCRelease message being used to indicate entry into or maintenance of RRC inactive state.

In one embodiment, the first message includes a suspendConfig field.

In one embodiment, the first message is a suspendConfig field in an RRCRelease message.

In one embodiment, the first message includes an RRC field that includes sdt-Config in its name.

In one embodiment, the first message includes an RRC field that includes sdt-DRB-List in its name.

In one embodiment, the first message includes an RRC field that includes sdt-SRB2-Indication in its name.

In one embodiment, the first message includes an RRC field that includes sdt-MAC-PHY-CG-Config in its name.

In one embodiment, the first message includes an RRC field that includes at least one of MBS or List or MRB or sdt or multi or mutiple or inactive or IMBS or Config in its name.

In one embodiment, the first message includes an RRC field that includes sdt-MRB-List in its name.

In one embodiment, the first message includes an index of each radio bearer in the target radio bearer set.

In one embodiment, the first message includes an index of the first radio bearer.

In one embodiment, the target radio bearer set is used for SDT.

In one embodiment, the target radio bearer set is used for MT-SDT.

In one embodiment, the target radio bearer set is used for MO-SDT.

In one embodiment, the target radio bearer set is used for MBS.

In one embodiment, the target radio bearer set is used for multicast MBS.

In one embodiment, all radio bearers in the target radio bearer set are DRBs.

In one embodiment, all radio bearers in the target radio bearer set are multicast MRBs.

In one embodiment, all radio bearers in the target radio bearer set are SRBs.

In one embodiment, any two radio bearers in the target radio bearer set are of the same type.

In one embodiment, the first message can be used to indicate a timer T380.

In one embodiment, the first message cannot be used to indicate a timer T380.

In one embodiment, the first message is used to determine to enter RRC inactive state.

In one embodiment, the first message is used to determine to maintain RRC inactive state.

In one embodiment, the first message indicates entry into or maintenance of RRC inactive state.

In one embodiment, the RRC inactive state is not RRC_CONNECTED state.

In one embodiment, the RRC inactive state is RRC_INACTIVE state.

In one embodiment, the RRC inactive state is RRC_IDLE state.

In one embodiment, the first message is used to trigger the first node's entry into or maintenance of the RRC inactive state.

In one embodiment, the first message is used to indicate the first node's entry into or maintenance of the RRC inactive state.

In one embodiment, the first message comprising an indication is used to determine to enter or maintain the RRC inactive state.

In one embodiment, the first message comprising suspendConfig is used to determine to enter or maintain the RRC inactive state.

In one embodiment, the first message comprising suspendConfig1 is used to determine to enter or maintain the RRC inactive state.

In one embodiment, the first message comprising suspendConfig2 is used to determine to enter or maintain the RRC inactive state.

In one embodiment, the first message comprising the second message is used to determine to enter or maintain the RRC inactive state.

In one embodiment, as a response to the first message being received, entering or maintaining the RRC inactive state.

In one embodiment, as a response to the first message being received, if the first action set is performed, entering or maintaining the RRC inactive state after the first action set has been performed.

In one embodiment, as a response to the first message being received, if the first action set is not performed, entering or maintaining the RRC inactive state after the second action set has been performed.

In one embodiment, if the first node is in RRC connected state before the first message is received, the “entering or maintaining RRC inactive state” means entering RRC inactive state.

In one embodiment, if the first node is in RRC inactive state before the first message is received, the “entering or maintaining RRC inactive state” means maintaining RRC inactive state.

In one embodiment, the first message comprises one RRC field, the one RRC field being used to configure SDT; the second message belongs to the one RRC field.

In one subembodiment, the first message is the one RRC field.

In one subembodiment, the one RRC field is used to indicate each radio bearer in the target radio bearer set.

In one subembodiment, the sdt-DRB-List-r17 in the one RRC field is used to indicate each radio bearer in the target radio bearer set.

In one subembodiment, the one RRC field includes an index of each radio bearer in the target radio bearer set.

In one subembodiment, the one RRC field includes sdt-Config in its name.

In one subembodiment, the one RRC field is sdt-Config-r17.

In one subembodiment, the one RRC field is sdt-Config-r18.

In one subembodiment, the one RRC field is sdt-Config.

In one embodiment, the first message comprises one RRC field, the one RRC field being used for configurations for receiving multicast MBS services in RRC inactive state; the second message belongs to the one RRC field.

In one subembodiment, the first message is the one RRC field.

In one subembodiment, the one RRC field is used to indicate each radio bearer in the target radio bearer set.

In one subembodiment, a field that includes sdt-DRB-List in its name in the one RRC field is used to indicate each radio bearer in the target radio bearer set.

In one subembodiment, the one RRC field includes an index of each radio bearer in the target radio bearer set.

In one subembodiment, the one RRC field is used to configure multicast MBS.

In one subembodiment, the one RRC field is used to configure multicast MRB.

In one subembodiment, the one RRC field includes sdt-Config in its name.

In one subembodiment, the one RRC field includes sdt-Config1 in its name.

In one subembodiment, the one RRC field includes sdt-Config2 in its name.

In one subembodiment, the one RRC field includes MBS-Config in its name.

In one subembodiment, the one RRC field includes IMBS-Config in its name.

In one subembodiment, the one RRC field includes at least one of MBS or List or MRB or sdt or multi or mutiple or inactive or IMBS or Config in its name.

In one embodiment, the action determining whether to perform a first action set at least according to whether a first condition set is satisfied comprises: whether to perform the first action set being related to at least whether the first condition set is satisfied.

In one embodiment, the action determining whether to perform a first action set at least according to whether a first condition set is satisfied comprises: performing the first action set only if the first condition set is satisfied.

In one embodiment, as a response to the first message being received, performing the first action set only when all conditions in the first condition set are satisfied.

In one embodiment, the first action set only includes suspending the first radio bearer.

In one embodiment, the first action set includes at least one action other than suspending the first radio bearer.

In one embodiment, the target radio bearer set includes only one radio bearer.

In one embodiment, the target radio bearer set includes one or more radio bearers.

In one embodiment, the target radio bearer set is for the first node.

In one embodiment, the target radio bearer set includes all DRBs configured for the first node.

In one embodiment, the target radio bearer set includes all DRBs and SRB2 configured for the first node.

In one embodiment, the target radio bearer set includes all DRBs and SRB2 configured for the first node.

In one embodiment, the target radio bearer set includes a DRB configured for SDT.

In one embodiment, the target radio bearer set includes a DRB configured for MO-SDT.

In one embodiment, the target radio bearer set includes a DRB configured for MT-SDT.

In one embodiment, the target radio bearer set includes a multicast MRB configured for receiving multicast MBS services in RRC inactive state.

In one embodiment, one radio bearer in the target radio bearer set is a radio bearer capable of transmitting or receiving data with the RRC inactive state being recovered.

In one embodiment, one radio bearer in the target radio bearer set is a Radio Bearer (RB).

In one embodiment, one radio bearer in the target radio bearer set is a DRB.

In one embodiment, one radio bearer in the target radio bearer set is an SRB.

In one embodiment, one radio bearer in the target radio bearer set is an MRB.

In one embodiment, one radio bearer in the target radio bearer set is a multicast MRB.

In one embodiment, one radio bearer in the target radio bearer set is SRB2.

In one embodiment, each radio bearer in the target radio bearer set is a DRB.

In one embodiment, each radio bearer in the target radio bearer set is an MRB.

In one embodiment, each radio bearer in the target radio bearer set is SRB2.

In one embodiment, each radio bearer in the target radio bearer set is at least one of a DRB or an MRB or SBR2.

In one embodiment, the target radio bearer set does not include SRB0.

In one embodiment, the target radio bearer set does not include SRB0.

In one embodiment, the target radio bearer set does not include SRB1.

In one embodiment, each radio bearer in the target radio bearer set is indicated by one RRC field in the first message.

In one subembodiment, the one RRC field includes at least one of sdt or DRB or List or inactive or MRB or 1 or 2 in its name.

In one subembodiment, the one RRC field is sdt-DRB-List.

In one subembodiment, the one RRC field is inactive-MRB-List.

In one subembodiment, the one RRC field is sdt-MRB-List1.

In one subembodiment, the one RRC field is sdt-MRB-List2.

In one subembodiment, the one RRC field includes an identifier of each radio bearer in the target radio bearer set.

In one subembodiment, the identifier of a radio bearer is indicated by a DRB-Identity.

In one subembodiment, the identifier of a radio bearer is indicated by an MRB-Identity.

In one embodiment, the first radio bearer belongs to the target radio bearer set.

In one embodiment, the first radio bearer is any radio bearer in the target radio bearer set.

In one embodiment, the first radio bearer is a radio bearer in the target radio bearer set that is indicated by the second message.

In one embodiment, the second message is the same as the first message.

In one embodiment, the second message is different from the first message.

In one embodiment, the second message is a field in the first message.

In one embodiment, the second message and the first message are two different RRC messages.

In one embodiment, the second message comprises an RRC message.

In one embodiment, the second message is an RRC message.

In one embodiment, the second message is an RRC field.

In one embodiment, the second message comprises at least one RRC field.

In one embodiment, the second message is an RRC IE.

In one embodiment, the second message comprises at least one RRC IE.

In one embodiment, the second message is not a part of the first message.

In one embodiment, the second message and the first message are two different RRC messages.

In one embodiment, the second message is an RRCReconfiguration message.

In one embodiment, the second message is a SIB1 message.

In one embodiment, the second message comprises one bit.

In one embodiment, the second message comprises at least one bit.

In one embodiment, the second message comprises one bit string.

In one embodiment, the second message comprises a Boolean value.

In one embodiment, the second message is a part of the first message.

In one embodiment, a second message field in the first message indicates the second message.

In one embodiment, the second message is a field in the first message.

In one embodiment, the data type of the second message is BIT STRING.

In one embodiment, the data type of the second message being BIT STRING is used to determine that the second message comprises the bitmap.

In one embodiment, the second message is used to indicate whether a state of the first radio bearer is maintained.

In one embodiment, the second message explicitly indicates whether a state of the first radio bearer is maintained.

In one embodiment, the second message implicitly indicates whether a state of the first radio bearer is maintained.

In one embodiment, the second message is used to determine maintaining of a state of the first radio bearer, or, alternatively, the second message is used to determine suspending of the first radio bearer.

In one embodiment, the second message indicates maintaining of a state of the first radio bearer, or, alternatively, the second message indicates suspending of the first radio bearer.

In one embodiment, if the second message is received, the first action set is not performed; if the second message is not received, performing the first action set.

In one embodiment, one condition in the first condition set is related to a format of the second message.

In one embodiment, one condition in the first condition set is related to content of the second message.

In one embodiment, one condition in the first condition set is related to a field in the second message.

In one embodiment, one condition in the first condition set is related to a transmitter of the second message.

In one embodiment, one condition in the first condition set is related to a type of a radio bearer bearing the second message.

In one embodiment, at least one condition in the first condition set is related to the second message.

In one embodiment, each condition in the first condition set is related to the second message.

In one embodiment, the first condition set includes one condition, the one condition being related to the second message.

In one embodiment, at least one condition in the first condition set is related to the second message, and at least one condition in the first condition set is independent of the second message.

In one embodiment, the second message is used to determine whether the first condition set is satisfied.

In one embodiment, at least the second message indicating whether to maintain a state of the first radio bearer or suspend the first radio bearer is used to determine whether the first condition set is satisfied.

In one embodiment, at least whether the second message is included in the first message is used to determine whether the first condition set is satisfied.

In one embodiment, at least whether the second message is received is used to determine whether the first condition set is satisfied.

In one embodiment, a condition in the first condition set is related to whether the second message indicates maintaining of a state of the first radio bearer or suspending of the first radio bearer.

In one subembodiment, as a response to the first message being received, the condition in the first condition set is satisfied if the second message indicates suspending of the first radio bearer.

In one subembodiment, as a response to the first message being received, the first condition set is satisfied if the second message indicates suspending of the first radio bearer.

In one subembodiment, as a response to the first message being received, the first condition set is not satisfied if the second message indicates maintaining of a state of the first radio bearer.

In one embodiment, one condition in the first condition set is related to whether the second message is included in the first message.

In one subembodiment, as a response to the first message being received, the first condition set is satisfied if the second message is not included in the first message.

In one subembodiment, as a response to the first message being received, the one condition in the first condition set is satisfied if the second message is not included in the first message.

In one subembodiment, as a response to the first message being received, the first condition set is not satisfied if the second message is included in the first message.

In one subembodiment, as a response to the first message being received, the first action set is performed only when the second message is included in the first message.

In one embodiment, as a response to the first message being received, the first action set is performed only when the second message is not received.

In one embodiment, one condition in the first condition set is related to whether the second message is received.

In one subembodiment, as a response to the first message being received, the first condition set is satisfied if the second message is not received.

In one subembodiment, as a response to the first message being received, the one condition in the first condition set is satisfied if the second message is not received.

In one subembodiment, as a response to the first message being received, the first condition set is not satisfied if the second message is received.

In one subembodiment, as a response to the first message being received, the first action set is performed only when the second message is not received.

In one embodiment, the action of suspending the first radio bearer comprises: a PDCP entity corresponding to the first radio bearer not receiving data from a higher layer.

In one embodiment, the action of suspending the first radio bearer comprises: a PDCP entity corresponding to the first radio bearer not transmitting data to a lower layer.

In one embodiment, the action of suspending the first radio bearer comprises: inactivating a PDCP corresponding to the first radio bearer.

In one embodiment, the suspending means to suspend.

In one embodiment, the suspending means to pause.

In one embodiment, the action of maintaining the state of the first radio bearer includes: not suspending the first radio bearer if the first radio bearer is not suspended upon reception of the first message.

In one embodiment, the action of maintaining the state of the first radio bearer includes: the state of the first radio bearer remaining unchanged before the first message is received and after the first message is received.

In one embodiment, the sentence “performing the first action set if the first condition set is satisfied; and the first action set being not performed if at least one condition in the first condition set is not satisfied” comprises: performing the first action set only when the first condition set is satisfied.

In one embodiment, the sentence “performing the first action set if the first condition set is satisfied; and the first action set being not performed if at least one condition in the first condition set is not satisfied” comprises: performing the first action set if the first condition set is satisfied.

In one embodiment, the phrase the first action set being not performed comprises that each action in the first action set is not performed.

In one embodiment, the phrase the first action set being not performed comprises that at least one action in the first action set is not performed.

In one embodiment, the phrase the first action set being not performed comprises: maintaining the state of the first radio bearer.

In one embodiment, the phrase the first action set being not performed comprises: the first radio bearer being not suspended.

In one embodiment, if Q1 is equal to 0, as a response to the first message being received, suspending all radio bearers in the target radio bearer set.

In one embodiment, if Q1 is equal to 0, the first condition set is satisfied.

In one embodiment, if Q1 is equal to 0, the second message does not exist.

In one embodiment, if Q1 is equal to 0, sdt-SRB2-Indication is configured.

### Embodiment 2

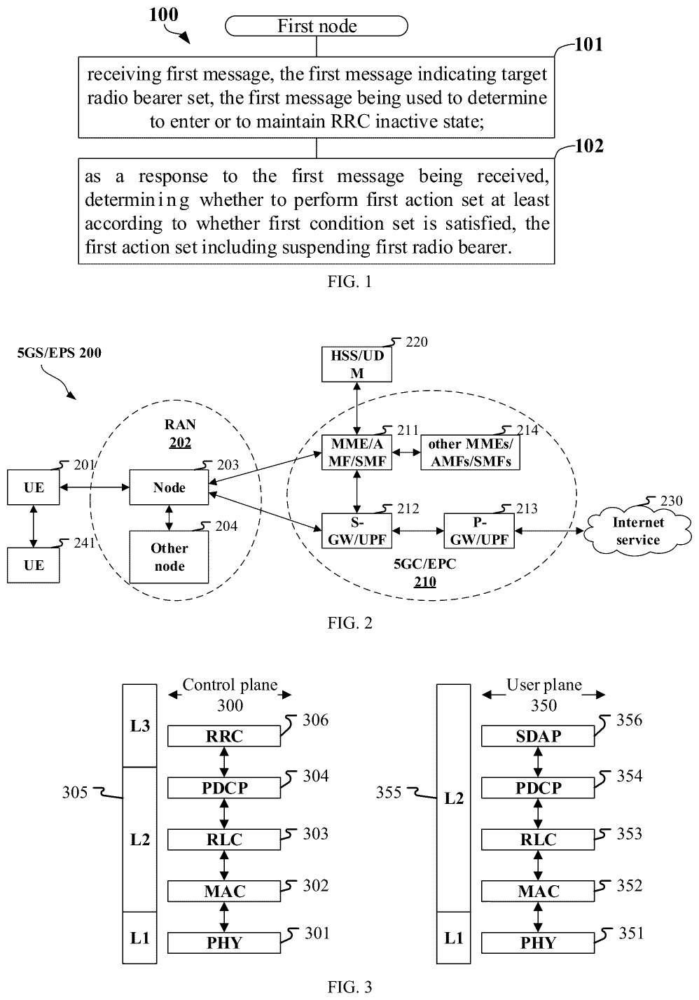

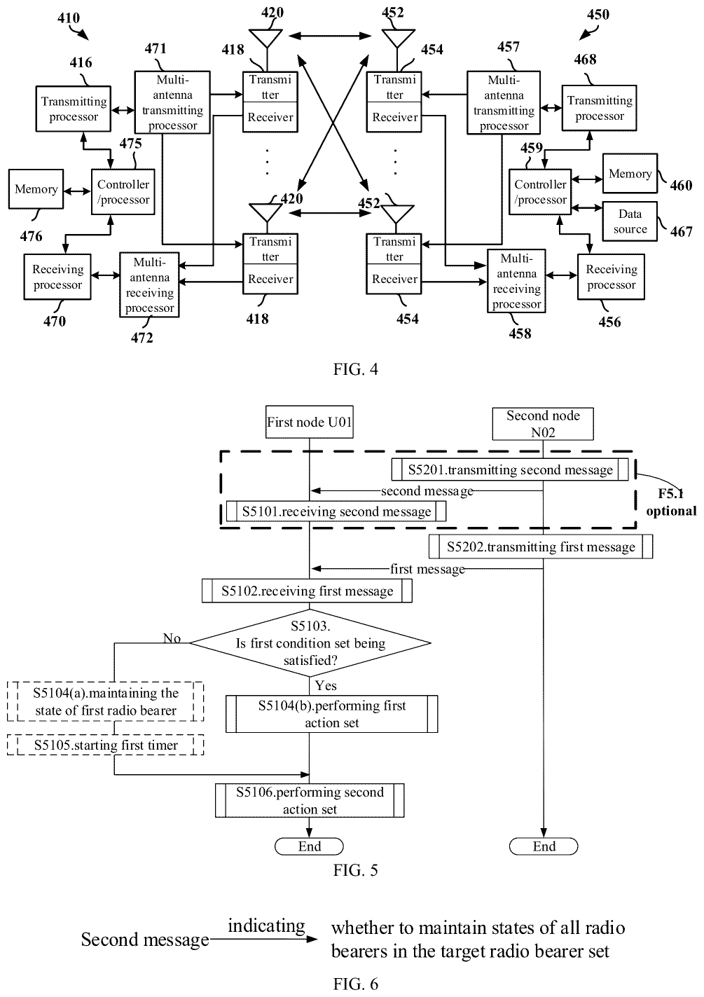

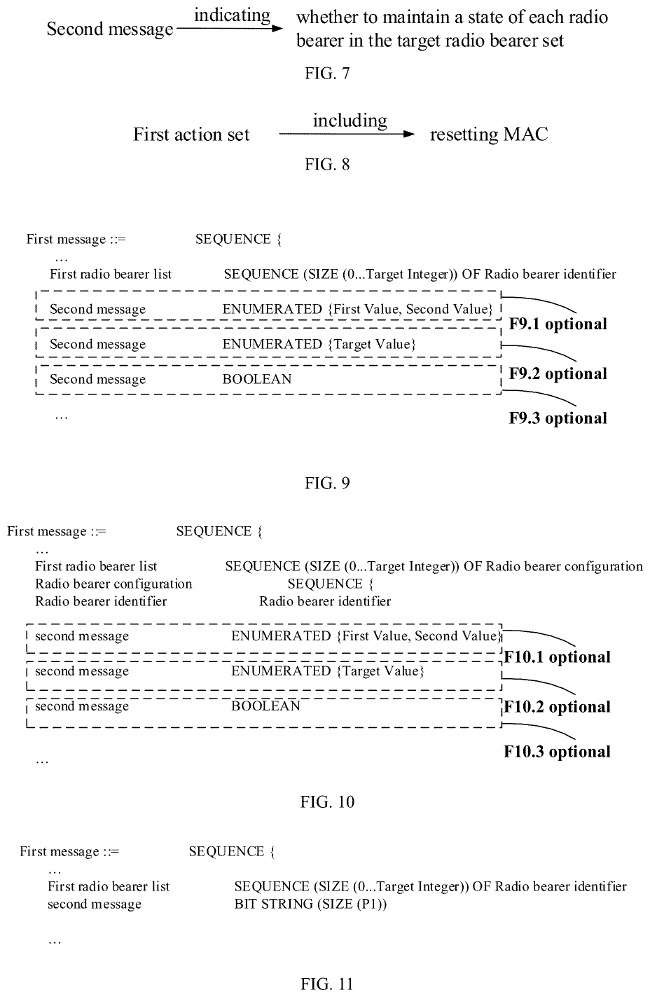

Embodiment 2 illustrates a schematic diagram of a network architecture according to one embodiment of the present application, as shown in FIG. 2. FIG. 2 illustrates a network architecture 200 of 5G New Radio (NR)/Long-Term Evolution (LTE)/Long-Term Evolution Advanced (LTE-A) systems. The 5G NR/LTE/LTE-A network architecture 200 may be called a 5G System/Evolved Packet System (5GS/EPS) 200 or other suitable terminology. The 5GS/EPS 200 may comprise UE(s) 201, a RAN 202, a 5G Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The

RAN comprises a node 203 and another node 204. The node 203 provides UE 201 oriented user plane and control plane terminations. The node 203 can be connected to other node 204 via an Xn interface (like backhaul)/X2 interface. The node 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The node 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy; a mobile client, a client or some other appropriate terms. The node 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 201 is a UE.

In one embodiment, the node 203 corresponds to the second node in the present application.

In one embodiment, the node 203 is a BaseStation (BS).

In one embodiment, the node 203 is a Base Transceiver Station (BTS).

In one embodiment, the node 203 is a NodeB (NB).

In one embodiment, the node 203 is a gNB.

In one embodiment, the node 203 is an eNB.

In one embodiment, the node 203 is a ng-eNB.

In one embodiment, the node 203 is an en-gNB.

In one embodiment, the node 203 is a UE.

In one embodiment, the node 203 is a relay.

In one embodiment, the node 203 is a Gateway.

In one embodiment, the UE supports transmissions in Non-Terrestrial Network (NTN).

In one embodiment, the UE supports transmissions in Terrestrial Network (TN).

In one embodiment, the UE supports transmissions in large-delay-difference networks.

In one embodiment, the UE supports Dual Connection (DC) transmissions.

In one embodiment, the UE comprises an aircraft.

In one embodiment, the UE comprises a vehicle-mounted terminal.

In one embodiment, the UE comprises a vessel.

In one embodiment, the UE comprises an Internet-of-Things (IoT) terminal.

In one embodiment, the UE comprises an Industrial IoT (IIoT) terminal.

In one embodiment, the UE comprises a piece of equipment supporting transmissions with low delay and high reliability.

In one embodiment, the UE comprises test equipment.

In one embodiment, the UE comprises a signaling test instrument.

In one embodiment, the base station supports transmissions in NTN.

In one embodiment, the base station supports transmissions in large-delay-difference networks.

In one embodiment, the base station supports transmissions in TN.

In one embodiment, the base station comprises a MacroCellular base station.

In one embodiment, the base station comprises a Micro Cell base station.

In one embodiment, the base station comprises a Pico Cell base station.

In one embodiment, the base station comprises a Femtocell.

In one embodiment, the base station comprises a base station device supporting large time-delay difference.

In one embodiment, the base station comprises a flight platform.

In one embodiment, the base station comprises satellite equipment.

In one embodiment, the base station comprises a Transmitter Receiver Point (TRP).

In one embodiment, the base station comprises a Centralized Unit (CU).

In one embodiment, the base station comprises a Distributed Unit (DU).

In one embodiment, the base station comprises test equipment.

In one embodiment, the base station comprises a signaling test instrument.

In one embodiment, the base station comprises an Integrated Access and Backhaul-node (IAB-node).

In one embodiment, the base station comprises an IAB-donor.

In one embodiment, the base station comprises an IAB-donor-CU.

In one embodiment, the base station comprises an IAB-donor-DU.

In one embodiment, the base station comprises an IAB-DU.

In one embodiment, the base station comprises an IAB-MT.

In one embodiment, the relay comprises a relay.

In one embodiment, the relay comprises a L3 relay.

In one embodiment, the relay comprises a L2 relay.

In one embodiment, the relay comprises a Router.

In one embodiment, the relay comprises an Exchanger.

In one embodiment, the relay comprises a UE.

In one embodiment, the relay comprises a base station.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 is represented by three layers, which are layer1, layer2 and layer3. The layer 1 (L1) is the lowest layer which performs signal processing functions of various PHY layers. The L1 is called PHY 301 in the present application. The layer 2 (L2) 305 is above the PHY 301, and is in charge of the link between the UE and the gNB via the PHY 301. The L2 305 comprises a Medium Access Control (MAC) sublayer 302, a Radio Link Control (RLC) sublayer 303 and a Packet Data Convergence Protocol (PDCP) sublayer 304. The PDCP sublayer 304 provides multiplexing among variable radio bearers and logical channels. The PDCP sublayer 304 provides security by encrypting a packet and provides support for inter-cell handover. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling. The radio protocol architecture in the user plane 350 comprises the L1 layer and the L2 layer. In the user plane 350, the radio protocol architecture used for a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics.

In one embodiment, the radio protocol architecture in FIG. 3 is applicable to the first node in the present application.

In one embodiment, the radio protocol architecture in FIG. 3 is applicable to the second node in the present application.

In one embodiment, the first message in the present application is generated by the RRC306.

In one embodiment, the first message in the present application is generated by the MAC302 or the MAC352.

In one embodiment, the first message in the present application is generated by the PHY301 or the PHY351.

In one embodiment, the second message in the present application is generated by the RRC306.

In one embodiment, the second message in the present application is generated by the MAC302 or the MAC352.

In one embodiment, the second message in the present application is generated by the PHY301 or the PHY351.

### Embodiment 4

Embodiment 4 illustrates a schematic diagram of a first communication device and a second

communication device according to the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping of signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450—targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with the memory 460 that stores program code and data; the memory 460 may be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data; the memory 476 may be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory. The at least one memory comprises computer program codes; the at least one memory and the computer program codes are configured to be used in collaboration with the at least one processor. The first communication device 450 at least receives a first message, the first message indicating a target radio bearer set, the first message being used to determine to enter or to maintain RRC inactive state; and as a response to the first message being received, determines whether to perform a first action set at least according to whether a first condition set is satisfied, the first action set including suspending a first radio bearer; herein, the target radio bearer set includes at least one radio bearer, and the first radio bearer is one radio bearer in the target radio bearer set; a condition in the first condition set is related to a second message, the second message being used to determine whether to maintain a state of the first radio bearer; the action of determining whether to perform a first action set at least according to whether a first condition set is satisfied includes: performing the first action set if the first condition set is satisfied; and the first action set being not performed if at least one condition in the first condition set is not satisfied.

In one embodiment, the first communication device 450 comprises a memory that stores a computer readable instruction program. The computer readable instruction program generates actions when executed by at least one processor. The actions include: receiving a first message, the first message indicating a target radio bearer set, the first message being used to determine to enter or to maintain RRC inactive state; and as a response to the first message being received, determining whether to perform a first action set at least according to whether a first condition set is satisfied, the first action set including suspending a first radio bearer; herein, the target radio bearer set includes at least one radio bearer, and the first radio bearer is one radio bearer in the target radio bearer set; a condition in the first condition set is related to a second message, the second message being used to determine whether to maintain a state of the first radio bearer; the action of determining whether to perform a first action set at least according to whether a first condition set is satisfied includes: performing the first action set if the first condition set is satisfied; and the first action set being not performed if at least one condition in the first condition set is not satisfied.

In one embodiment, the second communication device 410 comprises at least one processor and at least one memory. The at least one memory comprises computer program codes; the at least one memory and the computer program codes are configured to be used in collaboration with the at least one processor. The second communication device 410 at least transmits a first message, the first message indicating a target radio bearer set, the first message being used to determine to enter or to maintain RRC inactive state; herein, as a response to the first message being received, at least whether a first condition set is satisfied is used to determine whether to perform a first action set, the first action set including suspending a first radio bearer; the target radio bearer set includes at least one radio bearer, and the first radio bearer is one radio bearer in the target radio bearer set; a condition in the first condition set is related to a second message, the second message being used to determine whether to maintain a state of the first radio bearer; the phrase that at least whether a first condition set is satisfied is used to determine whether to perform a first action set includes; the first action set being performed if the first condition set is satisfied; and the first action set being not performed if at least one condition in the first condition set is not satisfied.

In one embodiment, the second communication device 410 comprises a memory that stores a computer readable instruction program. The computer readable instruction program generates an action when executed by at least one processor. The action includes: transmitting a first message, the first message indicating a target radio bearer set, the first message being used to determine to enter or to maintain RRC inactive state; herein, as a response to the first message being received, at least whether a first condition set is satisfied is used to determine whether to perform a first action set, the first action set including suspending a first radio bearer; the target radio bearer set includes at least one radio bearer, and the first radio bearer is one radio bearer in the target radio bearer set; a condition in the first condition set is related to a second message, the second message being used to determine whether to maintain a state of the first radio bearer; the phrase that at least whether a first condition set is satisfied is used to determine whether to perform a first action set includes: the first action set being performed if the first condition set is satisfied; and the first action set being not performed if at least one condition in the first condition set is not satisfied.

In one embodiment, the antenna 452, the receiver 454, the receiving processor 456 and the controller/processor 459 are used for receiving a first message; at least one of the antenna 420, the transmitter 418, the transmitting processor 416 or the controller/processor 475 is used for transmitting a first message.

In one embodiment, the antenna 452, the receiver 454, the receiving processor 456 and the controller/processor 459 are used for receiving a second message; at least one of the antenna 420, the transmitter 418, the transmitting processor 416 or the controller/processor 475 is used for transmitting a second message.

In one embodiment, the antenna 452, the receiver 454, the receiving processor 456 and the controller/processor 459 are used for receiving at least one piece of downlink data belonging to the first radio bearer; at least one of the antenna 420, the transmitter 418, the transmitting processor 416 or the controller/processor 475 is used for transmitting at least one piece of downlink data belonging to the first radio bearer.

In one embodiment, the antenna 452, the transmitter 454, the transmitting processor 468 and the controller/processor 459 are used for transmitting at least one piece of uplink data belonging to the first radio bearer; at least one of the antenna 420, the receiver 418, the receiving processor 470 or the controller/processor 475 is used for receiving at least one piece of uplink data belonging to the first radio bearer.

In one embodiment, the first communication device 450 corresponds to the first node in the present application.

In one embodiment, the second communication device 410 corresponds to the second node in the present application.

In one embodiment, the first communication device 450 is a UE.

In one embodiment, the first communication device 450 is a UE supporting large delay difference.

In one embodiment, the first communication device 450 is a UE supporting NTN.

In one embodiment, the first communication device 450 is an aircraft.

In one embodiment, the first communication device 450 is capable of positioning.

In one embodiment, the first communication device 450 is incapable of positioning.

In one embodiment, the first communication device 450 is a UE supporting TN.

In one embodiment, the second communication device 410 is a base station (gNB/eNB/ng-eNB).

In one embodiment, the second communication device 410 is a base station supporting large delay difference.

In one embodiment, the second communication device 410 is a base station supporting NTN.

In one embodiment, the second communication device 410 is satellite equipment.

In one embodiment, the second communication device 410 is a flight platform.

In one embodiment, the second communication device 410 is a base station supporting TN.

### Embodiment 5

Embodiment 5 illustrates a flowchart of radio signal transmission according to one embodiment of the present application, as shown in FIG. 5. It should be particularly noted that the sequence illustrated herein does not set any limit to the signal transmission order or implementation order in the present application.

The first node U01 receives a second message in step S5101; and receives a first message in step S5102, the first message indicating a target radio bearer set, the first message being used to determine to enter or to maintain RRC inactive state; in step S5103, as a response to the first message being received, determines whether a first condition set is satisfied, and determines whether or not to perform a first action set at least according to whether a first condition set is satisfied, the first action set including suspending a first radio bearer; if at least one condition in the first condition set is not satisfied, proceeding to step S5104(a), and if the first condition set is satisfied, proceeding to step S5104(b); in step S5104(a), maintains the state of the first radio bearer; in step S5104(b), performs the first action set; in step S5105, starts a first timer; and in step S5106, performs a second action set as a response to the first message being received.

The second node N02 transmits the second message in step S5201; and transmits the first message in step S5202.

In Embodiment 5, the target radio bearer set includes at least one radio bearer, and the first radio bearer is one radio bearer in the target radio bearer set; a condition in the first condition set is related to a second message, the second message being used to determine whether to maintain a state of the first radio bearer; the action of determining whether to perform a first action set at least according to whether a first condition set is satisfied includes: performing the first action set if the first condition set is satisfied; and the first action set being not performed if at least one condition in the first condition set is not satisfied; expiration of the first timer is used to determine to enter RRC idle state; the action of performing a second action set is independent of whether the first condition set is satisfied; the second action set includes suspending at least a second radio bearer, the second radio bearer not being indicated by the first message.

In one embodiment, the first node is a UE.

In one embodiment, the first node is a relay device.

In one embodiment, the second node is a base station.

In one embodiment, the second node is a relay device.

In one embodiment, not suspending the first radio bearer is used to determine maintaining of the state of the first radio bearer.

In one embodiment, if at least one condition in the first condition set is not satisfied, a state of the first radio bearer is maintained as a response to receiving the first message; when the first message is received, the state of the first radio bearer is not suspended.

In one embodiment, if at least one condition in the first condition set is not satisfied, a state of the first radio bearer is resumed as a response to receiving the first message; when the first message is received, the state of the first radio bearer is suspended.

In one embodiment, if at least one condition in the first condition set is not satisfied, the first timer is not started as a response to receiving the first message.

In one embodiment, the action of starting the first timer comprises: the first timer starting timing.

In one embodiment, the action of starting the first timer comprises: the first timer starting timing from 0.

In one embodiment, the action of starting the first timer comprises: starting the first timer.

In one embodiment, the action of starting the first timer comprises: restarting the first timer if the first timer is running.

In one embodiment, the first timer is a MAC layer timer.

In one embodiment, the first timer is an RRC layer timer.

In one embodiment, the first timer operates only in the RRC inactive state.

In one embodiment, the first timer is used for SDT.

In one embodiment, the first timer is used for multicast MBS.

In one embodiment, the first timer's expiration is used to determine SDT failure.

In one embodiment, the first timer's expiration is used to determine multicast MBS failure.

In one embodiment, the first timer is T319a.

In one embodiment, the first timer includes T319 in its name.

In one embodiment, the first timer is not T319.

In one embodiment, the first timer is T319b.

In one embodiment, the first timer is T319c.

In one embodiment, initiating an RRC recovery procedure for an SDT in RRC inactive state is used to determine the initiation of the first timer.

In one subembodiment, if conditions for initiating the SDT are satisfied, it is considered that the RRC recovery procedure is for the SDT.

In one subsidiary embodiment of the above subembodiment, the RRC recovery procedure is used for an uplink SDT.

In one subsidiary embodiment of the above subembodiment, the RRC recovery procedure is used for MO-SDT.

In one subsidiary embodiment of the above subembodiment, the conditions for initiating the SDT include: a higher layer requesting an RRC connection recovery.

In one subsidiary embodiment of the above subembodiment, the conditions for initiating the SDT include: the SIB1 comprises sdt-ConfigCommon.

In one subsidiary embodiment of the above subembodiment, the conditions for initiating the SDT include: sdt-Config being configured.

In one subsidiary embodiment of the above subembodiment, the conditions for initiating the SDT include: all pieces of uplink pending data being mapped to a radio bearer configured for the SDT.

In one subsidiary embodiment of the above subembodiment, the conditions for initiating the SDT include: a lower layer indicating that a condition for initiating the SDT is satisfied.

In one subsidiary embodiment of the above subembodiment, the conditions for initiating the SDT include: a higher layer requesting an RRC connection recovery, and, the SIB1 comprising sdt-ConfigCommon, and, sdt-Config being configured, and, all pieces of uplink pending data being mapped to a radio bearer configured for the SDT, and, a lower layer indicating that a condition for initiating the SDT is satisfied.

In one subembodiment, if a paging message is received, the paging message indicates an SDT and the RRC recovery procedure is for the SDT.

In one subsidiary embodiment of the above subembodiment, the RRC recovery procedure is used for a downlink SDT.

In one subsidiary embodiment of the above subembodiment, the RRC recovery procedure is used for MT-SDT.

In one subsidiary embodiment of the above subembodiment, the paging message includes an identifier of the first node.

In one embodiment, during the time while the first timer is running, if an RRC message is received, the first timer is stopped.

In one subembodiment, the one RRC message is an RRCRelease message.

In one subembodiment, the one RRC message is an RRCResume message.

In one subembodiment, the one RRC message is an RRCSetup message.

In one subembodiment, the one RRC message is an RRCReject message.

In one embodiment, during the time while the first timer is running, if cell reselection is performed, stopping the first timer.

In one embodiment, during the time while the first timer is running, if a number of RLC retransmissions reaches a pre-configured maximum value, stopping the first timer.

In one embodiment, during the time while the first timer is running, if a random access procedure fails, stopping the first timer.

In one embodiment, if the first timer expires, entering RRC idle state.

In one embodiment, the first timer's expiration triggers entry into RRC idle state.

In one embodiment, the RRC idle state is RRC_IDLE state.

In one embodiment, the first timer's expiration means that the timing of the first timer reaches an expiration value of the first timer.

In one embodiment, the second action set is an action other than the first action set.

In one embodiment, the second action set includes one action.

In one embodiment, the second action set includes multiple actions.

In one embodiment, an action in the second action set includes: stopping T380 if the T380 is running.

In one embodiment, an action in the second action set includes: starting timer T380 if the first message includes the timer T380.

In one embodiment, an action in the second action set includes: stopping T320 if the T320 is running.

In one embodiment, an action in the second action set includes: stopping T316 if the T316 is running.

In one embodiment, an action in the second action set includes: stopping T331 if the T331 is running.

In one embodiment, an action in the second action set includes: entering RRC inactive state.

In one embodiment, if at least one condition in the first condition set is not satisfied, performing the second action set as a response to receiving the first message.

In one embodiment, if the first condition set is satisfied, as a response to receiving the first message, performing the first action set and performing the second action set.

In one embodiment, the second action set includes resetting MAC.

In one embodiment, the second action set does not include resetting MAC.

In one embodiment, the second radio bearer is not SRB0.

In one embodiment, as a response to the first message being received, if the first condition set is satisfied, performing the first action set, and, performing a second action set; if at least one condition in the first condition set is not satisfied, performing the second action set, and, the first action set being not performed.

In one embodiment, the action “performing the first action set, and, performing a second action set” comprises: suspending all DRBs, all SRBs, and all multicast MRBs other than SRB0.

In one embodiment, the action “performing the second action set, and, the first action set being not performed” comprises: suspending all radio bearers other than the first radio bearer.

In one embodiment, the action “performing the second action set, and, the first action set being not performed” comprises: suspending all radio bearers other than SRB0 and the target bearer set.

In one embodiment, the dashed-line box F5.1 is optional.

In one embodiment, the dashed-line box F5.1 exists.

In one embodiment, the dashed-line box F5.1 does not exist.

In one embodiment, the step 5104(a) is optional.

In one embodiment, the step 5104(a) exists.

In one embodiment, the step 5104(a) does not exist.

In one embodiment, the step 5105 is optional.

In one embodiment, the step 5105 exists.

In one embodiment, the step 5105 does not exist.

### Embodiment 6

Embodiment 6 illustrates a schematic diagram of a second message indicating whether to maintain states of all radio bearers in a target radio bearer set according to the present application.

In Embodiment 6, the second message indicates whether to maintain states of all radio bearers in the target radio bearer set; the second message indicating maintaining of the states of all radio bearers in the target radio bearer set is used to determine maintaining of a state of the first radio bearer.

In one embodiment, as a response to the first message being received, if the first condition set is satisfied, all radio bearers in the target radio bearer set are suspended; if at least one condition in the first condition set is not satisfied, all radio bearers in the target radio bearer set are maintained.

In one embodiment, if the second message indicates maintaining of the states of all radio bearers in the target radio bearer set, the first condition set is not satisfied.

In one embodiment, if the second message indicates suspending of all radio bearers in the target radio bearer set, the first condition set is satisfied.

In one embodiment, the second message is a part of the first message.

In one embodiment, the second message is not a part of the first message.

In one embodiment, the second message indicates whether to maintain the states of all radio bearers in the target radio bearer set or suspend all radio bearers in the target radio bearer set.

In one embodiment, the second message indicates maintaining of the states of all radio bearers in the target radio bearer set, or, the second message indicates suspending all radio bearers in the target radio bearer set.

In one embodiment, that the second message is present is used to determine maintaining of the states of all radio bearers in the target radio bearer set; that the second message is not present is used to determine suspending of the states of all radio bearers in the target radio bearer set.

In one embodiment, that the second message is set to a target value indicates maintaining of the states of all radio bearers in the target radio bearer set.

In one subembodiment, that the second message is not set to a target value indicates suspending of all radio bearers in the target radio bearer set.

In one subembodiment, that the second message is not present indicates suspending of all radio bearers in the target radio bearer set.

In one subembodiment, the target value is a character string.

In one subembodiment, the target value comprises at least one letter.

In one subembodiment, the target value is true.

In one subembodiment, the target value is enabled.

In one subembodiment, the target value is allowed.

In one subembodiment, the target value is active.

In one subembodiment, the target value is maintain.

In one embodiment, that the second message is set to a target value indicates suspending of all radio bearers in the target radio bearer set.

In one subembodiment, that the second message is not set to a target value indicates maintaining of the states of all radio bearers in the target radio bearer set.

In one subembodiment, that the second message is not present indicates maintaining of the states of all radio bearers in the target radio bearer set.

In one subembodiment, the target value is a character string.

In one subembodiment, the target value comprises at least one letter.

In one subembodiment, the target value is true.

In one subembodiment, the target value is enabled.

In one subembodiment, the target value is allowed.

In one subembodiment, the target value is active.

In one subembodiment, the target value is suspend.

In one embodiment, that the second message is set to a first value indicates maintaining of the states of all radio bearers in the target radio bearer set, and that the second message is set to a second value indicates suspending of all radio bearers in the target radio bearer set; the first value is different from the second value.

In one subembodiment, the first value is 1, and the second value is 0.

In one subembodiment, the first value is 0, and the second value is 1.

In one subembodiment, the first value is a character string, and the second value is another character string.

In one subembodiment, the first value is maintain, and the second value is suspend.

In one subembodiment, the second message is an RRC field.

In one subembodiment, the second message comprises 1 bit.

In one subembodiment, the second message occupies 1 bit.

In one subembodiment, the second message comprises a character string.

In one embodiment, if the second message indicates maintaining of the states of all radio bearers in the target radio bearer set, the second message indicates maintaining of a state of the first radio bearer.

In one embodiment, if the second message indicates suspending of all radio bearers in the target radio bearer set, the second message indicates suspending of the first radio bearer.

### Embodiment 7

Embodiment 7 illustrates a schematic diagram of a second message indicating whether to maintain a state of each radio bearer in a target radio bearer set according to one embodiment of the present application.

In Embodiment 7, the second message indicates whether to maintain a state of each radio bearer in the target radio bearer set; the second message is a part of the first message.

In one embodiment, the phrase that the second message indicates whether to maintain a state of each radio bearer in the target radio bearer set includes: the second message being used to determine a target radio bearer subset in the target radio bearer set, each radio bearer in the target radio bearer subset being maintained, and any radio bearer in the target radio bearer set other than the target radio bearer subset being not maintained.

In one embodiment, the second message indicates maintaining of each radio bearer in the target radio bearer subset.

In one embodiment, as a response to the first message being received, if the first condition set is satisfied, all radio bearers in the target radio bearer set are suspended; if at least one condition in the first condition set is not satisfied, all radio bearers in the target radio bearer set are maintained

In one embodiment, as a response to the first message being received, if the first condition set is satisfied, all radio bearers in the target radio bearer set are suspended; if at least one condition in the first condition set is not satisfied, all radio bearers in at least a target radio bearer subset are maintained.

In one embodiment, as a response to the first message being received, if the first condition set is satisfied, all radio bearers in the target radio bearer set are suspended; if at least one condition in the first condition set is not satisfied, all radio bearers in a target radio bearer subset are maintained, and all radio bearers in the target radio bearer set other than the radio bearers in the target radio bearer subset are suspended.

In one embodiment, each radio bearer in the target radio bearer subset belongs to the target radio bearer set, the target radio bearer subset includes at least one radio bearer, and the first radio bearer is a radio bearer in the target radio bearer subset.

In one embodiment, if the target radio bearer subset does not include any radio bearer, the first condition set is satisfied.

In one embodiment, if the target radio bearer subset includes at least one radio bearer, the first condition set is not satisfied.

In one embodiment, the target radio bearer subset does not include any radio bearer.

In one embodiment, the target radio bearer subset includes at least one radio bearer.

In one embodiment, the target radio bearer subset is the same as the target radio bearer set.

In one embodiment, the phrase that the second message is a part of the first message comprises: the second message being at least one field in the first message.

In one embodiment, the phrase that the second message is a part of the first message comprises: the second message being at least one IE in the first message.

In one embodiment, the phrase that the second message is a part of the first message comprises: the second message being one field in the first message.

In one embodiment, the phrase that the second message is a part of the first message comprises: the second message being one IE in the first message.

In one embodiment, each radio bearer in the target radio bearer set is of the same type.

In one embodiment, each radio bearer in the target radio bearer set is a DRB, or, each radio bearer in the target radio bearer set is an SRB, or, each radio bearer in the target radio bearer set is a multicast MRB.

In one embodiment, the second message indicates, with respect to any radio bearer in the target radio bearer set, whether or not to maintain a state of the any radio bearer.

In one embodiment, for any two radio bearers in the target radio bearer set, the second message can indicate maintaining of a state of one of the any two radio bearers, and, suspending of the other of the any two radio bearers.

In one embodiment, the second message can indicate maintaining of state(s) of at least one radio bearer in the target radio bearer set.

In one embodiment, the second message can indicate maintaining of state(s) of at least one radio bearer in the target radio bearer set and suspending of at least one radio bearer in the target radio bearer set.

In one embodiment, for each radio bearer in the target radio bearer set, the second message indicates whether to maintain a state of each radio bearer or to suspend each radio bearer.

### Embodiment 8

Embodiment 8 illustrates a schematic diagram of a first action set including resetting MAC according to one embodiment of the present application, as shown in FIG. 8.

In Embodiment 8, the first action set includes resetting MAC.

In one embodiment, the resetting MAC is resetting MAC of a Master Cell Group (MCG) and MAC of a Secondary Cell (SCG).

In one embodiment, MAC is reset if the first condition set is satisfied; the MAC is not reset if at least one condition in the first condition set is not satisfied.

In one embodiment, MAC of an MCG and MAC of an SCG are reset if the first condition set is satisfied; the MAC of the SCG is reset and the MAC of the MCG is not reset if at least one condition in the first condition set is not satisfied.

In one embodiment, MAC of an MCG and MAC of an SCG are reset if the first condition set is satisfied; the MAC of the SCG is not reset and the MAC of the MCG is not reset if at least one condition in the first condition set is not satisfied.

### Embodiment 9

Embodiment 9 illustrates a schematic diagram of structures of a first message and a second message according to one embodiment of the present application, as shown in FIG. 9.

In Embodiment 9, the first message comprises a first radio bearer list and the second message; the first radio bearer list indicates the target radio bearer set; the second message indicates whether to maintain states of all radio bearers in the target radio bearer set; the second message is a part of the first message.

In one embodiment, the data structure of the first radio bearer list is SEQUENCE.

In one embodiment, the first radio bearer list indicates a radio bearer identifier for each radio bearer in the target radio bearer set.

In one embodiment, the data structure of the second message is ENUMERATED.

In one embodiment, the data structure of the second message is BOOLEAN.

In one embodiment, the second message can be set to one of the first value in this application or the second value in this application.

In one embodiment, the second message can be set to the target value.

In one embodiment, the second message can be set to a BOOLEAN.

In one embodiment, the second message indicates maintaining of the states of all radio bearers in the target radio bearer set.

In one embodiment, the second message indicates suspending of all radio bearers in the target radio bearer set.

In one embodiment, the second message indicates maintaining of the states of all radio bearers in the target radio bearer set, or, the second message indicates suspending all radio bearers in the target radio bearer set.

In one embodiment, the second message indicating maintaining of the states of all radio bearers in the target radio bearer set is used to determine maintaining of a state of the first radio bearer.

In one embodiment, the second message indicating suspending of all radio bearers in the target radio bearer set is used to determine suspending of the first radio bearer.

In one embodiment, the dashed-line box F9.1 is optional.

In one embodiment, the dashed-line box F9.1 exists.

In one embodiment, the dashed-line box F9.1 does not exist.

In one embodiment, the dashed-line box F9.2 is optional.

In one embodiment, the dashed-line box F9.2 exists.

In one embodiment, the dashed-line box F9.2 does not exist.

In one embodiment, the dashed-line box F9.3 is optional.

In one embodiment, the dashed-line box F9.3 exists.

In one embodiment, the dashed-line box F9.3 does not exist.

In one embodiment, only one of the dashed-line box F9.1, or the dashed-line box F9.2, or the dashed-line box F9.3 is present.

In one embodiment, none of the dashed-line box F9.1, or the dashed-line box F9.2, or the dashed-line box F9.3 is present.

### Embodiment 10

Embodiment 10 illustrates a schematic diagram of structures of a first message and a second message according to another embodiment of the present application, as shown in FIG. 10.

In Embodiment 10, the first message comprises a first radio bearer list, the first radio bearer list including Q radio bearer configurations, each radio bearer configuration among the Q radio bearer configurations comprising a radio bearer identifier and a second message being used to indicate whether to maintain a state of each radio bearer in the target radio bearer set; the second message is a part of the first message.

In one embodiment, if a second message in one of the Q radio bearer configurations indicates maintenance of a state of a radio bearer in the one radio bearer configuration, the target radio bearer subset includes the radio bearer in the one radio bearer configuration.

In one embodiment, the target radio bearer subset includes radio bearer(s) among the Q radio bearers that maintains/maintain the state of the radio bearer(s) as indicated by the second message.

In one embodiment, the first radio bearer list includes a radio bearer identifier for each radio bearer in the target radio bearer set, and, the first radio bearer list includes a second message for each radio bearer.

In one embodiment, a second message in any of the Q radio bearer configurations is used to indicate whether to maintain a state of a radio bearer in the any radio bearer configuration.

In one embodiment, a second message in a radio bearer configuration is used to indicate whether to maintain the state of the first radio bearer; the radio bearer configuration includes an identifier for the first radio bearer.

In one embodiment, the Q radio bearer configurations correspond to radio bearers in the target radio

bearer set.

In one embodiment, a radio bearer identifier included in each of the Q radio bearer configurations indicates a radio bearer in the target radio bearer set.

In one embodiment, Q is the Q1 in the present application.

In one embodiment, Q is the Q2 in the present application.

In one embodiment, the SIZE (0 . . . Target Integer) is equal to the Q in this application.

In one embodiment, the SIZE (0 . . . Target Integer) is an integer no less than 0 and no greater than the target integer.

In one embodiment, the target integer is the first target integer of the present application.

In one embodiment, the target integer is the second target integer of the present application.

In one embodiment, each of the Q radio bearer configurations is indicated by an RRC IE or an RRC field.

In one subembodiment, each of the Q radio bearer configurations comprises one RRC IE or one RRC field.

In one subembodiment, the name of the one RRC IE or the one RRC field includes at least one of SDT or DRB or Config or maintain or suspend.

In one subembodiment, the name of the one RRC IE or the one RRC field includes at least one of 1 or MBS or IMBS or INACTIVE or multi or multiple or MRB or Config or maintain or suspend.

In one embodiment, the data structure of the second message is ENUMERATED.

In one embodiment, the data structure of the second message is BOOLEAN.

In one embodiment, the second message can be set to one of the first value in this application or the second value in this application.

In one embodiment, the second message can be set to the target value.

In one embodiment, the second message can be set to a BOOLEAN.

In one embodiment, the second message is optional.

In one embodiment, the second message is present.

In one embodiment, the second message is not present.

In one embodiment, the second message is present, and the second message is set to the first value.

In one embodiment, the second message is present, and the second message is set to the second value.

In one embodiment, the second message is present, and the second message is set to the target value.

In one embodiment, the dashed-line box F10.1 is optional.

In one embodiment, the dashed-line box F10.1 exists.

In one embodiment, the dashed-line box F10.1 does not exist.

In one embodiment, the dashed-line box F10.2 is optional.

In one embodiment, the dashed-line box F10.2 exists.

In one embodiment, the dashed-line box F10.2 does not exist.

In one embodiment, the dashed-line box F10.3 is optional.

In one embodiment, the dashed-line box F10.3 exists.

In one embodiment, the dashed-line box F10.3 does not exist.

In one embodiment, only one of the dashed-line box F10.1, or the dashed-line box F10.2, or the dashed-line box F10.3 is present.

In one embodiment, none of the dashed-line box F10.1, or the dashed-line box F10.2, or the dashed-line box F10.3 is present.

### Embodiment 11

Embodiment 11 illustrates a schematic diagram of structures of a first message and a second message according to a third embodiment of the present application, as shown in FIG. 11.

In Embodiment 11, the first message comprises a first radio bearer list and the second message; the first radio bearer list indicates the target radio bearer set; the second message comprises a bit string, the bit string indicating whether to maintain a state of each radio bearer in the target radio bearer set; the second message is a part of the first message.

In one embodiment, the data structure of the first radio bearer list is SEQUENCE.

In one embodiment, the first radio bearer list indicates a radio bearer identifier for each radio bearer in the target radio bearer set.

In one embodiment, the data structure of the second message is BIT STRING.

In one embodiment, the second message is one bit string.

In one embodiment, one bit in the one bit string corresponds to a radio bearer identifier for one radio bearer, and the value of the one bit in the one bit string is used to indicate whether the state of the one radio bearer is maintained.

In one embodiment, the one bit in the one bit string being set to 1 indicates maintenance of the state of the one radio bearer; the one bit in the one bit string being set to 0 indicates suspense of the one radio bearer.

In one subembodiment, the target radio bearer subset includes radio bearer(s) corresponding to the bit(s) set to 1 in the one bit string.

In one embodiment, the one bit in the one bit string being set to 0 indicates maintenance of the state of the one radio bearer; the one bit in the one bit string being set to 1 indicates suspense of the one radio bearer.

In one subembodiment, the target radio bearer subset includes radio bearer(s) corresponding to the bit(s) set to 0 in the one bit string.

In one embodiment, a bit in the one bit string corresponding to a radio bearer identifier for the first radio bearer is used to indicate whether a state of the first radio bearer is maintained.

In one embodiment, a bit in the one bit string corresponding to a radio bearer identifier for the first radio bearer being set to 1 indicates maintenance of the state of the first radio bearer; and a bit in the one bit string corresponding to a radio bearer identifier for the first radio bearer being set to 0 indicates suspense of the one radio bearer.

In one embodiment, a bit in the one bit string corresponding to a radio bearer identifier for the first radio bearer being set to 0 indicates maintenance of the state of the first radio bearer; and a bit in the one bit string corresponding to a radio bearer identifier for the first radio bearer being set to 1 indicates suspense of the one radio bearer.

In one embodiment, a 1st bit in the one bit string corresponds to a radio bearer with a radio bearer identifier equal to 1, a 2nd bit in the one bit string corresponds to a radio bearer with a radio bearer identifier equal to 2, and a 3rd bit in the one bit string corresponds to a radio bearer with a radio bearer identifier equal to 3 . . . and so on.

In one embodiment, a size of the one bit string is equal to P1 bits.

In one embodiment, a size of the one bit string is equal to SIZE (P1) bits.

In one embodiment, P1 is equal to the target integer.

In one embodiment, P1 is not equal to the target integer.

In one embodiment, P1 is the target integer.

In one embodiment, P1 is the Q1 in the present application.

In one embodiment, P1 is the Q2 in the present application.

In one embodiment, a size of the one bit string is fixed.

In one embodiment, a size of the one bit string is configurable.

In one embodiment, a size of the one bit string is pre-configured.

In one embodiment, the one bit string is a bitmap.

In one embodiment, the target integer is the first target integer of the present application.

In one embodiment, the target integer is the second target integer of the present application.

In one embodiment, the target integer is the Q1 in the present application.

In one embodiment, the target integer is the Q2 in the present application.

In one embodiment, the SIZE (0 . . . Target Integer) is equal to the Q1 in this application; the Target Integer is the first target integer.

In one embodiment, the SIZE (0 . . . Target Integer) is equal to the Q2 in this application; the Target Integer is the second target integer.

In one embodiment, the SIZE (0 . . . Target Integer) is an integer no less than 0 and no greater than the target integer.

### Embodiment 12

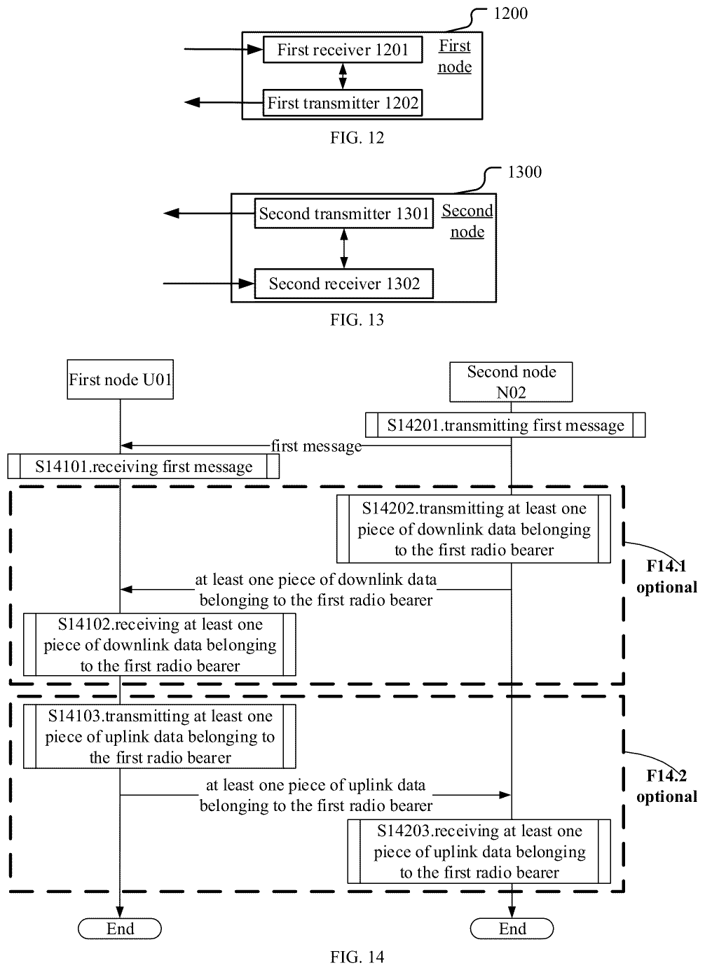

Embodiment 12 illustrates a structure block diagram of a processing device used in a first node according to one embodiment of the present application, as shown in FIG. 12. In FIG. 12, a processing device 1200 in a first node is comprised of a first receiver 1201 and a first transmitter 1202.

The first receiver 1201 receives a first message, the first message indicating a target radio bearer set, the first message being used to determine to enter or to maintain RRC inactive state; and as a response to the first message being received, determines whether to perform a first action set at least according to whether a first condition set is satisfied, the first action set including suspending a first radio bearer;

In Embodiment 12, the target radio bearer set includes at least one radio bearer, and the first radio bearer is one radio bearer in the target radio bearer set; a condition in the first condition set is related to a second message, the second message being used to determine whether to maintain a state of the first radio bearer; the action of determining whether to perform a first action set at least according to whether a first condition set is satisfied includes: performing the first action set if the first condition set is satisfied; and the first action set being not performed if at least one condition in the first condition set is not satisfied.

In one embodiment, the second message indicates whether to maintain states of all radio bearers in the target radio bearer set; the second message indicating maintaining of the states of all radio bearers in the target radio bearer set is used to determine maintaining of a state of the first radio bearer.

In one embodiment, the second message indicates whether to maintain a state of each radio bearer in the target radio bearer set; the second message is a part of the first message.

In one embodiment, the first receiver maintains the state of the first radio bearer as a response to receiving the first message if at least one condition in the first condition set is not satisfied.

In one embodiment, the first receiver starts a first timer as a response to receiving the first message if at least one condition in the first condition set is not satisfied; expiration of the first timer being used to determine to enter RRC idle state.

In one embodiment, the first receiver performs a second action set as a response to the first message being received; herein, the action of performing the second action set is independent of whether the first condition set is satisfied; the second action set includes suspending at least a second radio bearer, the second radio bearer being not indicated by the first message.

In one embodiment, the first action set includes resetting MAC.

In one embodiment, the first transmitter 1202, after the first message has been received, transmits at least one piece of uplink data belonging to the first radio bearer.

In one embodiment, the first receiver 1201, after the first message has been received, receives at least one piece of downlink data belonging to the first radio bearer.

In one embodiment, the first receiver 1201 receives the second message.

In one embodiment, the first receiver 1201 comprises the antenna 452, the receiver 454, the multi-antenna receiving processor 458, the receiving processor 456, the controller/processor 459, the memory 460 and the data source 467 in FIG. 4 of the present application.

In one embodiment, the first receiver 1201 comprises the antenna 452, the receiver 454, the multi-antenna receiving processor 458 and the receiving processor 456 in FIG. 4 of the present application.

In one embodiment, the first receiver 1201 comprises the antenna 452, the receiver 454 and the receiving processor 456 in FIG. 4 of the present application.

In one embodiment, the first transmitter 1202 comprises the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1202 comprises the antenna 452, the transmitter 454, the multi-antenna transmitting processor 457 and the transmitting processor 468 in FIG. 4 of the present application.

In one embodiment, the first transmitter 1202 comprises the antenna 452, the transmitter 454 and the transmitting processor 468 in FIG. 4 of the present application.

### Embodiment 13

Embodiment 13 illustrates a structure block diagram of a processing device used in a second node according to one embodiment of the present application, as shown in FIG. 13. In FIG. 13, a processing device 1300 in a second node is comprised of a second transmitter 1301 and a second receiver 1302.

The second transmitter 1301 transmits a first message, the first message indicating a target radio bearer set, the first message being used to determine to enter or to maintain RRC inactive state;

In Embodiment 13, as a response to the first message being received, at least whether a first condition set is satisfied is used to determine whether to perform a first action set, the first action set including suspending a first radio bearer; the target radio bearer set includes at least one radio bearer, and the first radio bearer is one radio bearer in the target radio bearer set; a condition in the first condition set is related to a second message, the second message being used to determine whether to maintain a state of the first radio bearer; the phrase that at least whether a first condition set is satisfied is used to determine whether to perform a first action set includes: the first action set being performed if the first condition set is satisfied; and the first action set being not performed if at least one condition in the first condition set is not satisfied.

In one embodiment, the second message indicates whether to maintain states of all radio bearers in the target radio bearer set; the second message indicating maintaining of the states of all radio bearers in the target radio bearer set is used to determine maintaining of a state of the first radio bearer.

In one embodiment, the second message indicates whether to maintain a state of each radio bearer in the target radio bearer set; the second message is a part of the first message.

In one embodiment, if at least one condition in the first condition set is not satisfied, the state of the first radio bearer is maintained as a response to receiving the first message.

In one embodiment, if at least one condition in the first condition set is not satisfied, a first timer is started as a response to receiving the first message; expiration of the first timer being used to determine to enter RRC idle state.

In one embodiment, as a response to the first message being received, a second action set is performed; herein, the action of performing the second action set is independent of whether the first condition set is satisfied; the second action set includes suspending at least a second radio bearer, the second radio bearer being not indicated by the first message.

In one embodiment, the first action set includes resetting MAC.

In one embodiment, the second transmitter 1301, after the first message has been transmitted, transmits at least one piece of downlink data belonging to the first radio bearer.

In one embodiment, the second receiver 1302, after the first message has been transmitted, receives at least one piece of uplink data belonging to the first radio bearer.

In one embodiment, the second transmitter 1301 transmits the second message.

In one embodiment, the second transmitter 1301 comprises the antenna 420, the transmitter 418, the multi-antenna transmitting processor 471, the transmitting processor 416, the controller/processor 475 and the memory 476 in FIG. 4 of the present application.

In one embodiment, the second transmitter 1301 comprises the antenna 420, the transmitter 418, the multi-antenna transmitting processor 471 and the transmitting processor 416 in FIG. 4 of the present application.

In one embodiment, the second transmitter 1301 comprises the antenna 420, the transmitter 418 and the transmitting processor 416 in FIG. 4 of the present application.

In one embodiment, the second receiver 1302 comprises the antenna 420, the receiver 418, the multi-antenna receiving processor 472, the receiving processor 470, the controller/processor 475 and the memory 476 in FIG. 4 of the present application.

In one embodiment, the second receiver 1302 comprises the antenna 420, the receiver 418, the multi-antenna receiving processor 472 and the receiving processor 470 in FIG. 4 of the present application.

In one embodiment, the second receiver 1302 comprises the antenna 420, the receiver 418 and the receiving processor 470 in FIG. 4 of the present application.

### Embodiment 14

Embodiment 14 illustrates a flowchart of signal transmission according to another embodiment of the present application, as shown in FIG. 14. It should be particularly noted that the sequence illustrated herein does not set any limit to the signal transmission order or implementation order in the present application.

The first node U01 receives a first message in step S14101, the first message indicating a target radio bearer set, the first message being used to determine to enter or to maintain RRC inactive state; and in step S14102, after the first message has been received, receives at least one piece of downlink data belonging to the first radio bearer; and in step S14103, after the first message has been received, transmits at least one piece of uplink data belonging to the first radio bearer.

The second node N02 transmits the first message in step S14201; and in step S14202, transmits at least one piece of downlink data belonging to the first radio bearer; and in step S14203, receives at least one piece of uplink data belonging to the first radio bearer.

In Embodiment 14, as a response to the first message being received, at least whether a first condition set is satisfied is used to determine whether to perform a first action set, the first action set including suspending a first radio bearer; the target radio bearer set includes at least one radio bearer, and the first radio bearer is one radio bearer in the target radio bearer set; a condition in the first condition set is related to a second message, the second message being used to determine whether to maintain a state of the first radio bearer; the phrase that at least whether a first condition set is satisfied is used to determine whether to perform a first action set includes: the first action set being performed if the first condition set is satisfied; and the first action set being not performed if at least one condition in the first condition set is not satisfied.

In one embodiment, after the first message is received, at least one piece of uplink data belonging to any of the radio bearers in the target radio bearer set is transmitted.

In one embodiment, after the first message is received, at least one piece of uplink data belonging to any of the radio bearers in the target radio bearer subset is transmitted.

In one embodiment, after the first message is received, at least one piece of downlink data belonging to any of the radio bearers in the target radio bearer set is received.

In one embodiment, after the first message is received, at least one piece of downlink data belonging to any of the radio bearers in the target radio bearer subset is received.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IoT), RFID terminals, NB-IoT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first message, the first message indicating a target radio bearer set, the first message being used to determine to enter or to maintain RRC inactive state; and as a response to the first message being received, determining whether to perform a first action set at least according to whether a first condition set is satisfied, the first action set including suspending a first radio bearer;
wherein the target radio bearer set includes at least one radio bearer, and the first radio bearer is one radio bearer in the target radio bearer set; a condition in the first condition set is related to a second message, the second message being used to determine whether to maintain a state of the first radio bearer; the action of determining whether to perform a first action set at least according to whether a first condition set is satisfied includes: performing the first action set if the first condition set is satisfied; and the first action set being not performed if at least one condition in the first condition set is not satisfied.

2. The first node according to claim 1, characterized in that the first message is a suspendConfig field in an RRCRelease message; the first message comprises suspendConfig being used to determine to enter or to maintain RRC inactive state; the RRC inactive state is RRC_INACTIVE state.

3. The first node according to claim 1, characterized in that the first message includes an index of each radio bearer in the target radio bearer set.

4. The first node according to claim 1, characterized in that the target radio bearer set includes at least one of Q1 DRBs, or Q2 multicast MRBs, or an SRB2.

5. The first node according to claim 1, characterized in that the target radio bearer set includes multiple radio bearers; the first radio bearer is any radio bearer in the target radio bearer set.

6. The first node according to claim 1, characterized in that each radio bearer in the target radio bearer set is one of a DRB, an MRB or an SRB2.

7. The first node according to claim 1, characterized in that the second message is a field in the first message; a condition in the first condition set is related to a format of the second message, and/or, a condition in the first condition set is related to content of the second message.

8. The first node according to claim 1, characterized in that a condition in the first condition set is related to whether the first message includes the second message; as a response to the first message being received, the first condition set is satisfied if the first message does not include the second message; as a response to the first message being received, the first condition is not satisfied if the first message includes the second message.

9. The first node according to claim 1, characterized in that the second message indicates whether to maintain a state of each radio bearer in the target radio bearer set; the second message is a part of the first message.

10. The first node according to claim 9, characterized in that the phrase that the second message indicates whether to maintain a state of each radio bearer in the target radio bearer set includes: the second message being used to determine a target radio bearer subset in the target radio bearer set, each radio bearer in the target radio bearer subset being maintained, and any radio bearer in the target radio bearer set other than the target radio bearer subset being not maintained.

11. The first node according to claim 9, characterized in that as a response to the first message being received, if the first condition set is satisfied, suspending all radio bearers in the target radio bearer set; if at least one condition in the first condition set is not satisfied, maintaining all radio bearers in a target radio bearer subset, and suspending all radio bearers in the target radio bearer set other than the radio bearers in the target radio bearer subset.

12. The first node according to claim 9, characterized in that if the target radio bearer subset does not include any radio bearer, the first condition set is satisfied; if the target radio bearer subset includes at least one radio bearer, the first condition set is not satisfied.

13. The first node according to claim 9, characterized in that the second message can indicate maintaining of state(s) of at least one radio bearer in the target radio bearer set.

14. The first node according to claim 1, characterized in comprising:
the first receiver, maintaining the state of the first radio bearer as a response to receiving the first message if at least one condition in the first condition set is not satisfied.

15. The first node according to claim 14, characterized in that the action of maintaining the state of the first radio bearer includes: not suspending the first radio bearer if the first radio bearer is not suspended upon reception of the first message.

16. The first node according to claim 1, characterized in comprising:
the first receiver, performing a second action set as a response to the first message being received;
wherein the action of performing the second action set is independent of whether the first condition set is satisfied; the second action set includes suspending at least a second radio bearer, the second radio bearer being not indicated by the first message.

17. The first node according to claim 16, characterized in that an action in the second action set includes: if a T320 is running, stopping the T320; and/or, an action in the second action set includes: if a T316 is running, stopping the T316; and/or, an action in the second action set includes: entering RRC inactive state; and/or, the second action set includes resetting MAC.

18. The first node according to claim 16, characterized in that if at least one condition in the first condition set is not satisfied, the second action set is performed as a response to receiving the first message; if the first condition set is satisfied, as a response to receiving the first message, the first action set is performed and the second action set is performed.

19. A second node for wireless communications, comprising:
a second transmitter, transmitting a first message, the first message indicating a target radio bearer set, the first message being used to determine to enter or to maintain RRC inactive state;
wherein as a response to the first message being received, at least whether a first condition set is satisfied is used to determine whether to perform a first action set, the first action set including suspending a first radio bearer; the target radio bearer set includes at least one radio bearer, and the first radio bearer is one radio bearer in the target radio bearer set; a condition in the first condition set is related to a second message, the second message being used to determine whether to maintain a state of the first radio bearer; the phrase that at least whether a first condition set is satisfied is used to determine whether to perform a first action set includes: the first action set being performed if the first condition set is satisfied; and the first action set being not performed if at least one condition in the first condition set is not satisfied.

20. A method in a first node for wireless communications, comprising:
receiving a first message, the first message indicating a target radio bearer set, the first message being used to determine to enter or to maintain RRC inactive state; and as a response to the first message being received, determining whether to perform a first action set at least according to whether a first condition set is satisfied, the first action set including suspending a first radio bearer;
wherein the target radio bearer set includes at least one radio bearer, and the first radio bearer is one radio bearer in the target radio bearer set; a condition in the first condition set is related to a second message, the second message being used to determine whether to maintain a state of the first radio bearer; the action of determining whether to perform a first action set at least according to whether a first condition set is satisfied includes: performing the first action set if the first condition set is satisfied; and the first action set being not performed if at least one condition in the first condition set is not satisfied.
